(19) United States
(12) Patent Application Publication
(10) Pub. No.: US 2011/0049322 A1
(43) Pub. Date: Mar. 3, 2011

(54) Novel Design For Mounting Assembly For Photovoltaic Arrays

(75) Inventors: William Pham, Carlsbad, CA (US); Andrew B. Goldin, Temecula, CA (US); Mark A. Parslow, Riverside, IL (US)

(73) Assignee: BAP POWER PTE. LTD., Carlsbad, CA (US)

(21) Appl. No.: 12/549,339

(22) Filed: Aug. 27, 2009

(51) Int. Cl. F16M 13/00; B23P 11/00

(52) U.S. Cl. 248/346.07; 248/346.03; 29/428

(57) ABSTRACT

A mounting assembly is described. The mounting assembly includes: (a) a pipe having a first threaded end and a second threaded end; (b) a base component having a base portion and a threaded connecting portion; (c) a top component having a top portion and a threaded portion, the top component being capable of supporting a photovoltaic panel thereon; and (d) wherein the first threaded end of the pipe and the threaded connecting portion of the base component include threads such that the first threaded end rotatably engages in a first direction with the threaded connecting portion, and the second threaded end of the pipe and the threaded portion of the top component include threads such that the first threaded end rotatably engages in a second direction with the threaded portion of the top component, the first direction is opposite to the second direction, and the first threaded end and the second threaded end are substantially cylindrical.

### BACKGROUND OF THE INVENTION

The present invention relates generally to mounting assemblies used for installation of photovoltaic arrays. More particularly, the present invention relates to improved designs of mounting assemblies which allow for their rapid assembly and rapid height adjustment.

FIG. 1 shows a conventional mounting assembly 10 used for installation of photovoltaic panels. Assembly 10 includes a base component 12 and a top component 14. Top component 14 has disposed at one end a supporting plate 16, and at another end a tube portion 18. During the assembly of a photovoltaic panel, the appropriate frame and railing are built on supporting plate 16. A photovoltaic panel (not shown to simplify illustration) is ultimately secured on the railing.

Tube portion 18 at one end connects to supporting plate 16 using set screws. At the other end, tube portion 18 connects to base component 12. Specifically, base component 12 has a cavity which is large enough to receive tube portion 18 as shown in FIG. 1. As a result, during assembly of mounting assembly 10, tube portion 18 is inserted into the cavity of base component 12 to secure at least a portion of the top component inside the base component.

Unfortunately, the conventional mounting assembly suffers from several drawbacks. By way of example, installing conventional mounting assemblies is a long and arduous task. It is not enough to assemble conventional mounting assemblies as shown in FIG. 1. A significant amount of time is spent leveling the mounting assembly. Typically surfaces are machined (e.g., using a laser for tight tolerances) and/or shims are used to strive for a leveled surface through various stages of component assembly process.

As another example, it is difficult to adjust a height of the conventional mounting assembly. Movement of various interconnected components comes into play to adjust the conventional assembly's height and in some instances, where the amount of adjustment is not significant, shims may be used. Regardless of how a height adjustment is accomplished, it is clear that the above-mentioned drawbacks associated with leveling compound the process of height adjustment in a conventional design.

As yet another example, even after enduring such cumbersome efforts, often times the resulting mounting assembly does not have the requisite flatness or is not level. Consequently, subsequent photovoltaic panels installed on conventional mounting assemblies are frequently crooked and/or are bent. Such crooked and bent panels are undesirable as they reduce the efficiency of the panel.

As yet another example, the conventional design with all the different interconnecting components involved, represents a complicated design that is expensive to implement.

What is therefore needed is a novel system and method of assembly a mounting assembly which does not suffer from the drawbacks encountered by conventional designs.

### SUMMARY OF THE INVENTION

In view of the foregoing, this invention provides novel systems and methods for implementing improved designs of mounting assemblies which allow for rapid assembly and rapid adjustment of height.

In one aspect, the present invention provides a mounting assembly. The mounting assembly includes: (i) a pipe having a first threaded end and a second threaded end; (ii) a base component having a base portion and a threaded connecting portion; (iii) a top component having a top portion and a threaded portion, the top component is capable of supporting a photovoltaic panel thereon; and (iv) wherein the first threaded end of the pipe and the threaded connecting portion of the base component include threads such that the first threaded end rotatably engages in a first direction with the threaded connecting portion, and the second threaded end of the pipe and the threaded portion of the top component include threads such that the first threaded end rotatably engages in a second direction with the threaded portion of the top component, the first direction is opposite to the second direction, and the first threaded end and the second threaded end are substantially cylindrical. Preferably, the pipe's cross section between the first threaded end and the second threaded end is a shape that is at least one of circular, triangular, and rectangular. The pipe may be made from an engineered material. The pipe is preferably made from a material that includes one member selected from a group consisting of aluminum, steel, fiberblass, plastic, alloy and treated materials that are galvanized, electrogalvanized and annealed. Preferably, the pipe has a diameter that is between about 1.25 inches and about 3.0 inches.

In one embodiment of the present invention, the base component is designed to be secured in concrete.

In preferred embodiments of the present invention, the first threaded end and the second threaded end include threads which extend to a depth that is between about 1 inch and about 3 inches, and more preferably, between about 1 inch and about 2 inches. In further preferred embodiments, the threaded connecting portion of the base component and the threaded portion of the top portion include threads which extend to a depth that is between about 1 inch and about 3 inches, and more preferably, between about 1 inch and about 2 inches.

In preferred embodiments of the present invention, the mounting assembly includes a frame that is capable of fastening to the top portion of the pipe. Further, the mounting assembly may include a rail which is secured upon the frame and is capable of having attached thereto a photovoltaic panel.

In another aspect, the present invention includes method for assembling a mounting assembly. The method includes: (i) immobilizing a base component on a surface, the base component including a base portion and a threaded connecting portion which includes threads; (ii) obtaining a pipe having first threaded end and a second threaded end, each of the first and the second threaded ends include threads; (iii) rotatably engaging threads of the first threaded end with threads of the threaded connecting portion of the bottom component to connect the bottom component and the pipe and forming a bottom subassembly; and (iv) rotatably engaging threads of the second threaded end with threads of the threaded portion of the top component to connect the bottom subassembly with the top component and forming the mounting assembly. Immobilizing may include securing a bottom part of the base component inside concrete.

In preferred embodiments of the present invention, inventive methods may include the further step of adjusting a height of the mounting assembly by rotating the threads of the first threaded end with respect to the threads of the threaded connecting portion. Inventive methods may further include the step of adjusting a height of the mounting assembly by rotating the threads of the second threaded end with respect to the threads of the threaded portion.

Preferred embodiments of the present invention may include the further step of leveling a height of the mounting assembly across a radial direction of the mounting assembly by rotating the threads of the first threaded end with respect to the threads of the threaded connecting portion. Inventive methods may further include the step of leveling a height of the mounting assembling across a radial direction of the mounting assembly by rotating the threads of the second threaded end with respect to the threads of the threaded portion.

Preferred embodiments may yet include the further step of fastening a frame to the top component using a fastening subassembly. The fastening subassembly may include U-shaped bolts straight bolts, screws, tabs with mounting holes, or other means of secondary attachment. The inventive method may further include the step of communicatively coupling a rail designed to secure a photovoltaic panel on the frame.

In another aspect, the present invention provides a mounting assembly. The mounting assembly includes: (i) a means for adjusting height of the mounting assembly, the means of adjusting including a first threaded end and a second threaded end; (ii) a means for immobilizing the mounting assembly including a threaded connecting portion; (iii) means for supporting a frame installed on the mounting assembly, the means for supporting including a threaded portion; and (iv) wherein the first threaded end and the threaded connecting portion include threads such that the first threaded end rotatably engages in a first direction with the threaded connecting portion, and the second threaded end and the threaded portion include threads such that the first threaded end rotatably engages in a second direction with the threaded portion, and the first direction is opposite to the second direction.

In preferred embodiments of the present invention, a pitch of threads on first and second threaded end 110 and 112, threaded portion 114 and threaded connecting portion 116 is a value that is between about 0.03 inches and about 0.11 inches, and is preferably between about 0.06 inches and about 0.11 inches.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1 shows a conventional mounting assembly.

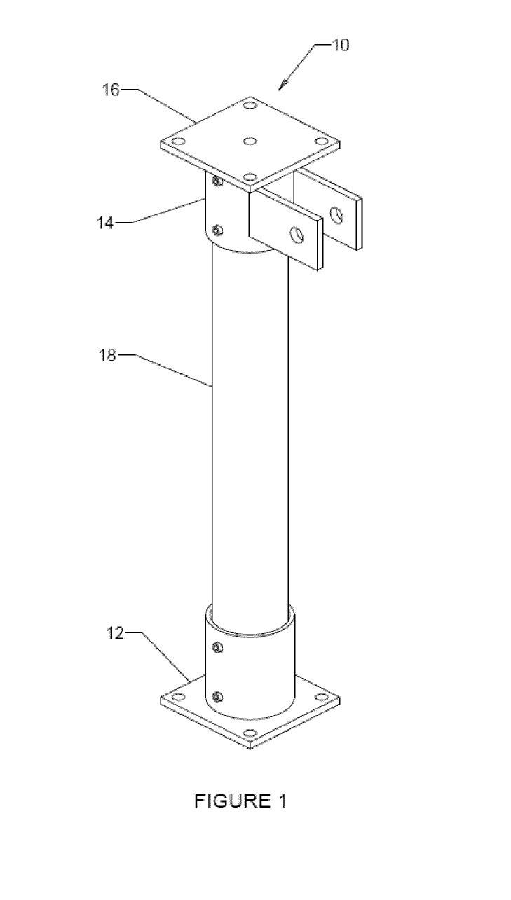

FIG. 2A shows a mounting assembly design, according to one embodiment of the present invention, for installing photovoltaic panels.

FIG. 2B shows an exploded perspective view of the mounting assembly of FIG. 2A.

FIG. 2C shows a mounting assembly design, according to an alternative embodiment of the present invention, in which a pipe has a rectangular intermediate portion.

FIGS. 3A-3E show a progression of the assembly process, according to one embodiment of the present invention, for the mounting assembly design shown in FIG. 2A.

FIG. 4 shows a photovoltaic panel array installed using mounting assembly design shown in FIG. 2A.

### DETAILED DESCRIPTION OF THE PREFERRED EMBODIMENTS

In the following description numerous specific details are set forth in order to provide a thorough understanding of the present invention. It will be apparent, however, to one skilled in the art that the present invention may be practiced without limitation to some or all of these specific details. In other instances, well known process steps have not been described in detail in order to not unnecessarily obscure the invention.

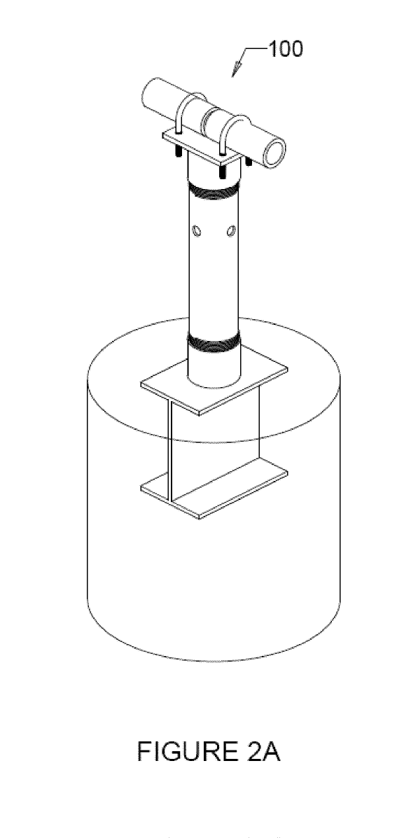

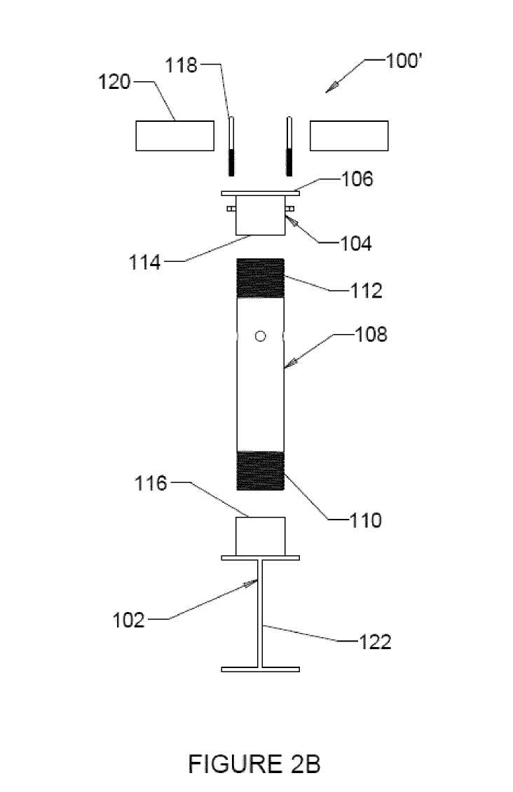

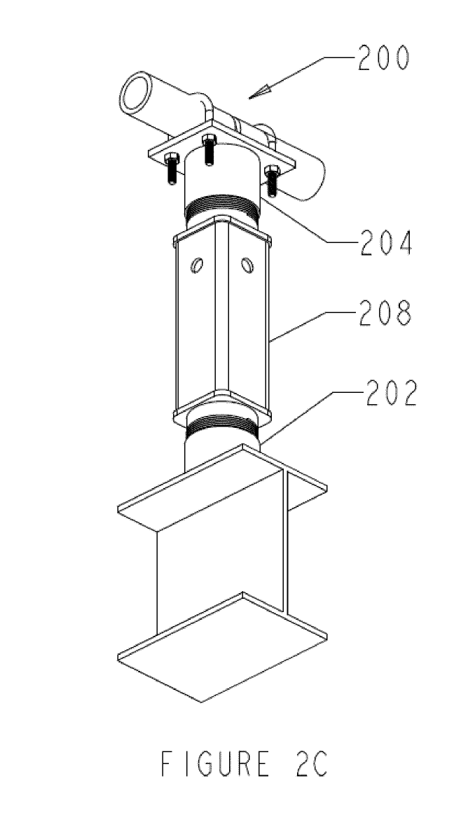

FIG. 2A shows a perspective view of a mounting assembly, according to one embodiment of the present invention, used for installation of photovoltaic panels. Details of the various components involved in the manufacture of assembly 100 are shown in greater detail in FIG. 2B discussed below.

FIG. 2B shows an exploded front view of mounting assembly 100. Mounting assembly 100 includes a pipe 108 disposed between a top component 104 and a base component 102. Pipe 108, top component 104, a base component 102 may be, but are not necessarily, made from similar material, which includes any engineered material. Preferably, however, pipe 108, top component 104 and base component 102 are made from at least one member selected from a group consisting of aluminum, steel, fiberglass, plastic, alloy, and treated materials that are galvanized, electrogalvanized and annealed.

Pipe 108 has a first threaded end 110 and a second threaded end 112. Each threaded end includes threads thereon. Base component 102 includes a threaded connecting portion 116 and a base portion 122. During installation of a photovoltaic panel, at least a bottom part of base portion 122 is preferably designed to be submerged in concrete. Threaded connecting portion 116 includes threads such that first threaded end 110 rotatably engages in a first direction with threaded connecting portion 116. In other words, the threads of first threaded end 110 are capable of rotating around the threads of threaded connecting portion 116 in a particular direction.

Top component 104 includes a threaded portion 114 and a top portion 106. Disposed on top portion 106 are cross-bars 120 using a pair of U-bolts 118, as shown in FIG. 2B. Threaded portion 114 includes threads such that threaded portion 114 rotatably engages in second direction with second threaded end 112—i.e., threads of threaded component 114 are capable of rotating around the threads of second threaded end 112. It is possible that the first direction and second direction are the same direction. However, for effective leveling of the partial or full mounting assembly, the second direction is preferably opposite to the first direction.

In accordance with one embodiment of the present invention, the threads on first and second threaded end 110 and 112, threaded portion 114 and threaded connecting portion 116 extend to a depth that is between about 1 inch and about 3 inches, preferably extend to a depth that is between about 1 inch and about 2 inches, and more preferably extend to a depth that is about 1.5 inches.

In preferred embodiments of the present invention, the pitch of threads on first and second threaded end 110 and 112, threaded portion 114 and threaded connecting portion 116 is a value that is between about 0.03 inches and about 0.11 inches, and is preferably between about 0.06 inches and about 0.11 inches.

Although according to FIG. 2B the interior of threaded connecting portion 116 and threaded portion 114 are threaded and the exterior of first threaded end 110 and second threaded end 112 are threaded, vice versa is also possible—i.e., exterior of threaded connecting portion 116 and threaded portion 114 are threaded and that interior of first threaded end 110 and second threaded 112 end are threaded.

Pipe 108 may be any shape, so long as first threaded end 110 and second threaded end 112 are cylindrical to effect rotational displacement. Moreover, an intermediate portion of pipe 108 that is located between first threaded end 110 and second threaded end 112 can have any shape. By way of example, the intermediate portion of pipe 108 has a cross-section that has a shape selected from a group consisting of circular, triangular and rectangular. The intermediate portion, which may well be a non-cylindrically shaped, is either welded to the cylindrically-shaped first and second threaded ends or is fastened using well known fastening hardware to the threaded ends. In the event pipe 108 is fabricated using a mold, then the intermediate portion is contiguous to the cylindrical threaded ends, and neither welds nor fastening assemblies are required.

FIG. 2C shows a mounting design assembly 200 having a pipe 208 with a rectangular shaped intermediate portion. Other components (e.g., base component 202 and top component 204 of assembly 200) are substantially similar to their counterparts (i.e., base component 102 and top component 104) shown in FIG. 2B.

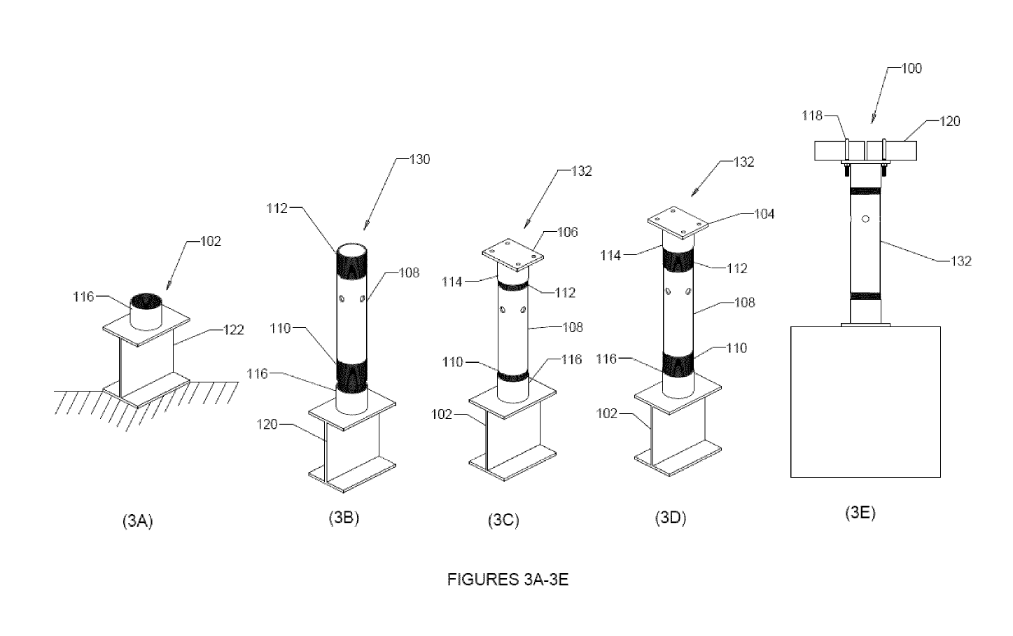

FIG. 3A-3E shows a progression of the assembly process, according to one embodiment of the present invention, of the inventive mounting assemblies. According to FIG. 3A, a base component 102, in its upright vertical position, is immobilized. This may be accomplished by submerging a bottom part of base component 102 in concrete, which subsequently hardens and as a result, secures base component 102 in the concrete. Before the concrete hardens, however, base component 102 is leveled using techniques well known to those skilled in the art. Alternatively, before leveling, the base may be secured by well known fastening hardware to a supporting surface (e.g., a concrete slab or a rooftop).

Next, as shown in FIG. 3B, a pipe 108 is communicatively coupled to base component 102 by engaging their respective threads and form a bottom subassembly 130. In its engaged position, first threaded end 110 of pipe 108 rotates around a radial direction of threaded connecting portion 116 and also moves down along its axis, i.e., a length of threaded connecting portion 116.

At the other end of pipe 108, a top component 104 is similarly connected. Specifically, as shown in FIG. 3C, threaded portion 114 of top component 104 is communicatively coupled to a second threaded end 112 by engaging their respective threads. As a result, top component 104 connects to bottom subassembly 130 to form an adjustable subassembly 132. In its engaged position, threaded portion 114 of top component 104 rotates around a radial direction of second threaded end 112 and also moves down along its axis, i.e., a length of second threaded end 112.

The above-mentioned threaded connections between various components allow the present invention to rapidly and easily adjust the height of the inventive mounting assemblies. As shown in FIG. 3D, by rotating first threaded end 110 relative to base component 102 in a clockwise and/or counter-clockwise direction and/or rotating threaded portion 114 of top component 104 relative to pipe 106 in a counter-clockwise and/or clockwise direction, the present inventions provide the advantages of rapidly leveling the inventive mounting assemblies during installation of a photovoltaic panel. This feature of the present invention represents a marked improvement over the conventional design. Specifically, the present invention reduces the number of interconnecting components required to assemble the inventive mounting assemblies. By reducing the number of components and offering simple connecting designs, the present invention realizes an increased throughput and a decreased cost of assembly that is not realized by the conventional design of mounting assembly.

FIG. 3E is a front view of the mounting assembly 100 resulting after implementing the various steps mentioned above and presents a different view of mounting assembly 100 shown in FIG. 2A. FIGS. 2A and 2B shows plates (not specifically denoted by a reference numeral to simplify illustration) which attach by welding to base component 102 and top component 104.

After mounting assemblies are assembled according to the above-mentioned inventive processes, preferably a frame is built on cross-bars 120 (of FIG. 2B). Next, a rail (e.g., about 20 feet long) is installed above the frame and is designed to secure photovoltaic panels thereon. In preferred embodiments of the present invention, two mounting assemblies combine to form a structure upon which frames and rails are built so that a photovoltaic panel having a length that is between about 2 feet and about 8 feet is installed. It is noteworthy that when two mounting assemblies, according to the present invention are used to install a photovoltaic panel, the tasks of adjusting height and leveling are significantly easy over the conventional design. Both height adjustment and leveling of the inventive mounting assemblies is accomplished by simply rotating threads on first threaded end 110 relative to threads on threaded connecting portion 116 and/or by rotating threads on second threaded end 112 relative to threads on threaded portion 114.

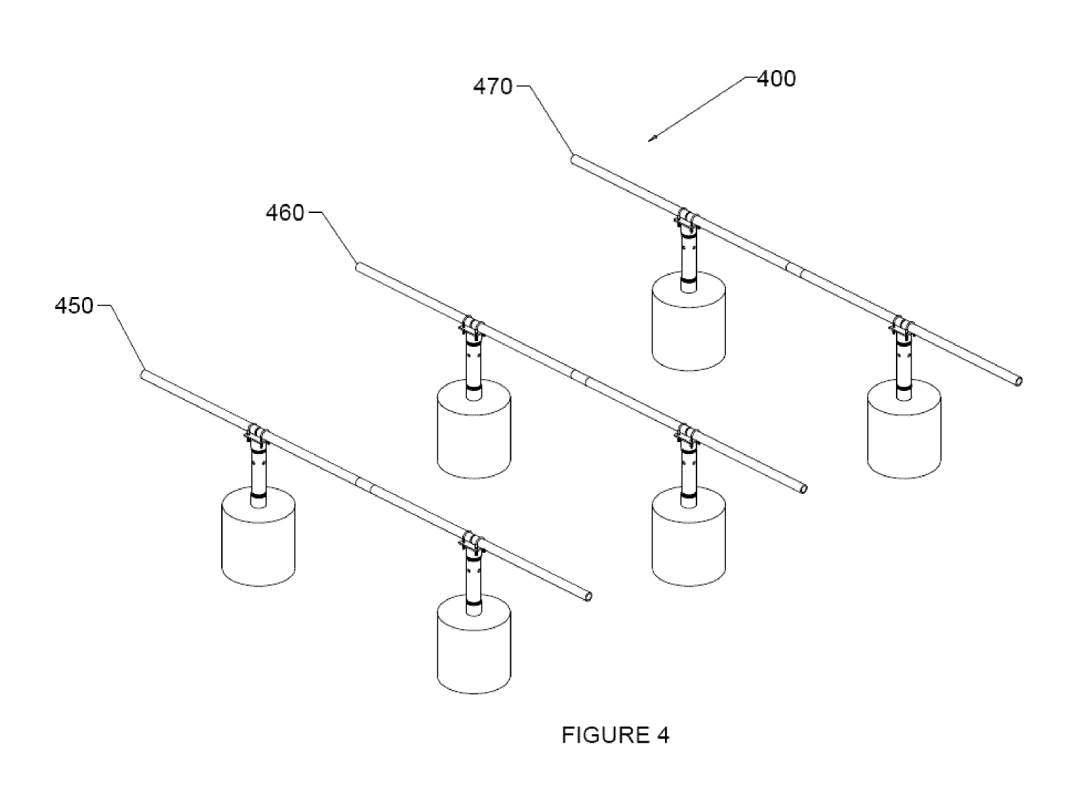

FIG. 4 shows a photovoltaic panel array 400 installed using mounting assembly design shown in FIG. 2A. By way of example, FIG. 4 shows three rows of mounting assemblies—450, 460 and 470, for array 400. Array 400, however, may consist of more or less than three rows of mounting assemblies. Furthermore, more or less than two mounting assemblies may be used to secure a single photovoltaic panel, as shown in FIG. 4. However, it is preferable to use two mounting assemblies (such as the one shown in FIG. 2A) to secure a single photovoltaic panel.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A mounting assembly, comprising:
a pipe having a first threaded end and a second threaded end;
a base component having a base portion and a threaded connecting portion;
a top component having a top portion and a threaded portion, said top component being capable of supporting a photovoltaic panel thereon; and
wherein said first threaded end of said pipe and said threaded connecting portion of said base component include threads such that said first threaded end rotatably engages in a first direction with said threaded connecting portion, and said second threaded end of said pipe and said threaded portion of said top component include threads such that said first threaded end rotatably engages in a second direction with said threaded portion of said top component, said first direction is opposite to said second direction, and said first threaded end and said second threaded end are substantially cylindrical.

2. The mounting assembly of claim 1, wherein said cross-section of said pipe between said first threaded end and said second threaded end has a shape that is at least one selected from a group consisting of circular, triangular, and rectangular.

3. The mounting assembly of claim 1, wherein said pipe is made from a material that includes one member selected from a group consisting of aluminum, steel, fiberglass, plastic, alloy, and treated materials that are galvanized, electrogalvanized, and annealed.

4. The mounting assembly of claim 1, further comprising a rail which is secured upon said frame and is capable of having attached thereto a photovoltaic panel.

5. The mounting assembly of claim 1, wherein said pipe has a diameter that is between about 1.25 inches and about 3.0 inches.

6. The mounting assembly of claim 1, wherein said first threaded end and said second threaded end include threads which extend to a depth that is between about 1 inch and 3 inches.

7. The mounting assembly of claim 6, wherein said first threaded end and said second threaded end include threads which extend to a depth that is between about 1 inch and about 2 inches.

8. The mounting assembly of claim 1, wherein said threaded connecting portion of said base component and said threaded portion of said top portion include threads which extend to a depth that is between about 1 inch and about 3 inches.

9. The mounting assembly of claim 8, wherein said threaded connecting portion of said base component and said threaded portion of said top portion include threads which extend to a depth that is between about 1 inch and about 2 inches.

10. The mounting assembly of claim 1, wherein a pitch of threads on said first threaded portion and said second threaded portion is value between about 0.03 inches and about 0.11 inches.

11. A method for assembling a mounting assembly, comprising:
immobilizing a base component on a surface, said base component including a base portion and a threaded connecting portion which includes threads;
obtaining a pipe having first threaded end and a second threaded end, each of said first and said second threaded ends include threads;
rotatably engaging threads of said first threaded end with threads of said threaded connecting portion of said bottom component to connect said bottom component and said pipe and forming a bottom subassembly;
rotatably engaging threads of said second threaded end with threads of said threaded portion of said top component to connect said bottom subassembly with said top component and forming said mounting assembly.

12. The method of assembling a mounting assembly of claim 11, wherein said immobilizing includes securing a bottom part of said base component inside concrete or on a supporting surface.

13. The method of assembling a mounting assembly of claim 11, further comprising adjusting a height of said mounting assembly by rotating said threads of said first threaded end with respect to said threads of said threaded connecting portion.

14. The method of assembling a mounting assembly of claim 11, further comprising adjusting a height of said mounting assembly by rotating said threads of said second threaded end with respect to said threads of said threaded portion.

15. The method of assembling a mounting assembly of claim 11, further comprising leveling a height of said mounting assembly across a radial direction of said mounting assembly by rotating said threads of said first threaded end with respect to said threads of said threaded connecting portion.

16. The method of assembling a mounting assembly of claim 11, further comprising leveling a height of said mounting assembling across a radial direction of said mounting assembly by rotating said threads of said second threaded end with respect to said threads of said threaded portion.

17. The method of assembling a mounting assembly of claim 11, further comprising fastening a frame to said top component using a fastening subassembly.

18. The method of assembling a mounting assembly of claim 16, wherein said fastening subassembly includes at least one member selected from a group consisting of U-shaped bolts, straight bolts, screws, and tabs with mounting holes.

19. The method of assembling a mounting assembly of claim 17, further comprising communicatively coupling a rail designed to secure a photovoltaic panel on said frame.

20. A mounting assembly, comprising:
means for adjusting height of said mounting assembly, said means of adjusting including a first threaded end and a second threaded end;
means for immobilizing said mounting assembling including a threaded connecting portion;
means for supporting a frame installed on said mounting assembly, said means for supporting including a threaded portion; and
wherein said first threaded end and said threaded connecting portion include threads such that said first threaded end rotatably engages in a first direction with said threaded connecting portion, and said second threaded end and said threaded portion include threads such that said first threaded end rotatably engages in a second direction with said threaded portion, and said first direction is opposite to said second direction.
